(19) United States
(12) Patent Application Publication
(10) Pub. No.: US 2017/0286952 A1
(43) Pub. Date: Oct. 5, 2017

(54) METHOD AND SYSTEM FOR NOTIFICATIONS TRIGGERED USING DATA TRACKING ALGORITHMS

(71) Applicant: MasterCard International Incorporated, Purchase, NY (US)

(72) Inventors: Jean-Pierre GERARD, Croton-On-Hudson, NY (US); Andrey BIRUKOV, Scarsdale`, NY (US)

(73) Assignee: MasterCard International Incorporated, Purchase, NY (US)

(21) Appl. No.: 15/085,149

(22) Filed: Mar. 30, 2016

(51) Int. Cl. G06Q 20/38; G06Q 20/40

(52) U.S. Cl. CPC G06Q 20/389; G06Q 20/4016

(57) ABSTRACT

A method for monitoring for unwanted recurring transactions includes: storing account profiles, each including a primary account number, communication details, and transaction data entries having data related to a completed transaction including a paid amount, merchant identifier, and indication of being a recurring or non-recurring transaction; receiving a transaction message related to a payment transaction, the transaction message including a specific primary account number, transaction amount, specific merchant identifier, and indication of a recurring payment transaction; identifying a specific account profile that includes the specific primary account number; determining a likelihood of an unwanted recurring payment based on a lack of transaction data entries in the specific account profile that include the specific merchant identifier and an indication of being a recurring transaction; and transmitting a notification to a computing device based on the communication details included in the identified specific account profile, the notification indicating the unwanted recurring transaction.

### FIELD

The present disclosure relates to triggering of a notification based on data tracking algorithms, specifically a notification of an unwanted recurring electronic transaction based on tracking of prior transactions including transaction frequency and transaction volume with and without the associated entity.

### BACKGROUND

Recurring transactions, including recurring payment transactions for the periodic payment of currency from a consumer to a merchant, can be beneficial to each entity involved for a number of reasons. For instance, an automatic recurring payment can be beneficial for a consumer as it enables them to regularly pay a fee for a good or service without the need to remember to explicitly initiate or approve such a payment, to continue to receive the good or service with less effort. For merchants, they can count on recurring payments for regular income, and, if the consumer neglects to use or retrieve their purchased good or service during a pay period, may receive the income with a higher profitability percentage.

Due to the high potential value of recurring transactions, many merchants often try to set up recurring transactions with consumers. In some cases, less genuine merchants may attempt to establish a recurring payment transaction without clearly or fully informing a consumer of the recurring nature of a transaction, or, in some instances, without the consumer's knowledge entirely. Such types of recurring transactions, known as “gray charges,” can occur in a variety of situations. For example, a consumer may purchase an item at a discount without being aware that a condition of the discount is that they begin a recurring payment to the merchant. In another example, a consumer may be offered a free trial to a service, which converts to a recurring transaction after a period of time, either unknown to the consumer when accepting the trial or known to the consumer with the consumer forgetting about the conversion. As a result, it can be important for a consumer to identify and remove unwanted recurring transactions from their account.

However, the removal of an unwanted recurring transaction can be a long and difficult process for consumers. First, the consumer must identify the unwanted recurring transaction, which may involve significantly monitoring of each of the consumer's transaction account and at a high frequency due to the varying periods for recurring transactions, and which may also be difficult to identify transactions that are recurring as opposed to individual, non-recurring transactions. Then, the consumer must identify the merchant to whom the recurring payment is being paid, which may be difficult to identify from the limited amount of data that may be indicated in their account statement. The consumer can then contact the merchant to cancel the recurring payment, which may be time consuming and difficult, particularly in instances if the merchant is a nefarious entity that may deliberately make the cancellation process difficult and with a long processing time. Alternatively, the consumer can dispute the charge and future payments with their issuer, which may result in an investigation, which can take a significant amount of time and require the consumer to provide evidence that the recurring payments are unwanted, which may also be difficult. These processes are time consuming, require multiple electronic and/or voice communications, tie up computing time, is prone to errors and misunderstandings, and is generally an inefficient or ineffective way to address the problem. As a result, the cancellation of an unwanted recurring transaction can take a significant amount of time and resources, and require a significant amount of effort on the part of the consumer.

### SUMMARY

Thus, there is a need for a technical solution for the identification of unwanted recurring payments and notification thereof to the associated consumer. Due to the significant amount of time and effort required by consumers to identify unwanted recurring payments, a technical solution to provide for automated identification of unwanted recurring payments in a way that is not possible by mere human thought and cannot be done with pen and paper but rather done quickly in a scalable fashion for reviewing tens of thousands and even millions of transactions, particularly at the time when a recurring payment is initiated, may provide for significantly higher consumer convenience, significantly decrease the time and effort required to stop unwanted recurring payments, and reduce the number of communications and steps required to cancel unwanted recurring payments.

The present disclosure provides a description of systems and methods for monitoring for unwanted recurring transactions.

A method for monitoring for unwanted recurring transactions includes: storing, in an account database of a processing server, a plurality of account profiles, wherein each account profile includes a structured data set related to a transaction account including at least a primary account number, communication details, and a plurality of transaction data entries, each transaction data entry including data related to a completed transaction involving the related transaction account including at least a paid amount, merchant identifier, and indication of the related complete transaction being a recurring or non-recurring transaction; receiving, by a receiving device of the processing server, a transaction message related to a payment transaction, wherein the transaction message is formatted pursuant to one or more standards and includes at least a plurality of data elements including at least a first data element configured to store a specific primary account number, a second data element configured to store a transaction amount, a third data element configured to store a specific merchant identifier, and a fourth data element configured to store an indication of a recurring payment transaction; executing, by a querying module of the processing server, a query on the account database to identify a specific account profile where the included primary account number corresponds to the specific primary account number stored in the first data element included in the received transaction message; determining, by a data identification module of the processing server, a likelihood of an unwanted recurring payment based on at least a lack of transaction data entries included in the identified specific account profile that include the specific merchant identifier and an indication of being a recurring transaction; and electronically transmitting, by a transmitting device of the processing server, a data signal to a computing device based on the communication details included in the identified specific account profile, wherein the data signal is superimposed with at least data stored in the plurality of data elements included in the received transaction message.

Another method for monitoring for unwanted recurring transactions includes: storing, in an account database of a processing server, a plurality of account profiles, wherein each account profile includes a structured data set related to a transaction account including at least a primary account number, communication details, and a plurality of transaction data entries, each transaction data entry including data related to a completed transaction involving the related transaction account including at least a paid amount, merchant identifier, and indication of the related complete transaction being a recurring or non-recurring transaction; receiving, by a receiving device of the processing server, a transaction message related to a payment transaction, wherein the transaction message is formatted pursuant to one or more standards and includes at least a plurality of data elements including at least a first data element configured to store a specific primary account number, a second data element configured to store a transaction amount, a third data element configured to store a specific merchant identifier, and a fourth data element configured to store an indication of a recurring payment transaction; executing, by a querying module of the processing server, a query on the account database to identify a specific account profile where the included primary account number corresponds to the specific primary account number stored in the first data element included in the received transaction message; identifying, by a data identification module of the processing server, at least one transaction data entry included in the identified specific account profile that includes the specific merchant identifier and an indication of being a recurring transaction; determining, by the data identification module of the processing server, a likelihood of an unwanted recurring payment based on at least the transaction amount stored in the second data element included in the received transaction message and the paid amount included in each of the identified at least one transaction data entries; and electronically transmitting, by a transmitting device of the processing server, a data signal to a computing device based on the communication details included in the identified specific account profile, wherein the data signal is superimposed with at least data stored in the plurality of data elements included in the received transaction message.

A system for monitoring for unwanted recurring transactions includes: an account database of a processing server configured to store a plurality of account profiles, wherein each account profile includes a structured data set related to a transaction account including at least a primary account number, communication details, and a plurality of transaction data entries, each transaction data entry including data related to a completed transaction involving the related transaction account including at least a paid amount, merchant identifier, and indication of the related complete transaction being a recurring or non-recurring transaction; a receiving device of the processing server configured to receive a transaction message related to a payment transaction, wherein the transaction message is formatted pursuant to one or more standards and includes at least a plurality of data elements including at least a first data element configured to store a specific primary account number, a second data element configured to store a transaction amount, a third data element configured to store a specific merchant identifier, and a fourth data element configured to store an indication of a recurring payment transaction; a querying module of the processing server configured to execute a query on the account database to identify a specific account profile where the included primary account number corresponds to the specific primary account number stored in the first data element included in the received transaction message; a data identification module of the processing server configured to determine a likelihood of an unwanted recurring payment based on at least a lack of transaction data entries included in the identified specific account profile that include the specific merchant identifier and an indication of being a recurring transaction; and a transmitting device of the processing server configured to electronically transmit a data signal to a computing device based on the communication details included in the identified specific account profile, wherein the data signal is superimposed with at least data stored in the plurality of data elements included in the received transaction message.

Another system for monitoring for unwanted recurring transactions includes: an account database of a processing server configured to store a plurality of account profiles, wherein each account profile includes a structured data set related to a transaction account including at least a primary account number, communication details, and a plurality of transaction data entries, each transaction data entry including data related to a completed transaction involving the related transaction account including at least a paid amount, merchant identifier, and indication of the related complete transaction being a recurring or non-recurring transaction; a receiving device of the processing server configured to receive a transaction message related to a payment transaction, wherein the transaction message is formatted pursuant to one or more standards and includes at least a plurality of data elements including at least a first data element configured to store a specific primary account number, a second data element configured to store a transaction amount, a third data element configured to store a specific merchant identifier, and a fourth data element configured to store an indication of a recurring payment transaction; a querying module of the processing server configured to execute a query on the account database to identify a specific account profile where the included primary account number corresponds to the specific primary account number stored in the first data element included in the received transaction message; a data identification module of the processing server configured to identify at least one transaction data entry included in the identified specific account profile that includes the specific merchant identifier and an indication of being a recurring transaction, and determine a likelihood of an unwanted recurring payment based on at least the transaction amount stored in the second data element included in the received transaction message and the paid amount included in each of the identified at least one transaction data entries; and a transmitting device of the processing server configured to electronically transmit a data signal to a computing device based on the communication details included in the identified specific account profile, wherein the data signal is superimposed with at least data stored in the plurality of data elements included in the received transaction message.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for the monitoring and notification of unwanted recurring payment transactions in accordance with exemplary embodiments.

FIG. 2 is a block diagram illustrating the processing server of FIG. 1 for the monitoring and notification of unwanted recurring transactions in accordance with exemplary embodiments.

FIG. 3 is a flow diagram illustrating a process for identification and notification of an unwanted recurring transaction using the processing server of FIG. 2 in accordance with exemplary embodiments.

FIGS. 4 and 5 are flow charts illustrating exemplary methods for monitoring for unwanted recurring transactions in accordance with exemplary embodiments.

FIG. 6 is a flow diagram illustrating the processing of a payment transaction in accordance with exemplary embodiments.

FIG. 7 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

Glossary of Terms

Payment Network—A system or network used for the transfer of money via the use of cash-substitutes for thousands, millions, and even billions of transactions during a given period. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Payment Rails—Infrastructure associated with a payment network used in the processing of payment transactions and the communication of transaction messages and other similar data between the payment network and other entities interconnected with the payment network that handles thousands, millions, and even billions of transactions during a given period. The payment rails may be comprised of the hardware used to establish the payment network and the interconnections between the payment network and other associated entities, such as financial institutions, gateway processors, etc. In some instances, payment rails may also be affected by software, such as via special programming of the communication hardware and devices that comprise the payment rails. For example, the payment rails may include specifically configured computing devices that are specially configured for the routing of transaction messages, which may be specially formatted data messages that are electronically transmitted via the payment rails, as discussed in more detail below.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require any special knowledge in offered products. In some embodiments, an entity involved in a single transaction may be considered a merchant. In some instances, as used herein, the term “merchant” may refer to an apparatus or device of a merchant entity.

Issuer—An entity that establishes (e.g., opens) a letter or line of credit in favor of a beneficiary, and honors drafts drawn by the beneficiary against the amount specified in the letter or line of credit. In many instances, the issuer may be a bank or other financial institution authorized to open lines of credit. In some instances, any entity that may extend a line of credit to a beneficiary may be considered an issuer. The line of credit opened by the issuer may be represented in the form of a payment account, and may be drawn on by the beneficiary via the use of a payment card. An issuer may also offer additional types of payment accounts to consumers as will be apparent to persons having skill in the relevant art, such as debit accounts, prepaid accounts, electronic wallet accounts, savings accounts, checking accounts, etc., and may provide consumers with physical or non-physical means for accessing and/or utilizing such an account, such as debit cards, prepaid cards, automated teller machine cards, electronic wallets, checks, etc.

### System for Monitoring and Notification of Unwanted Recurring Transactions

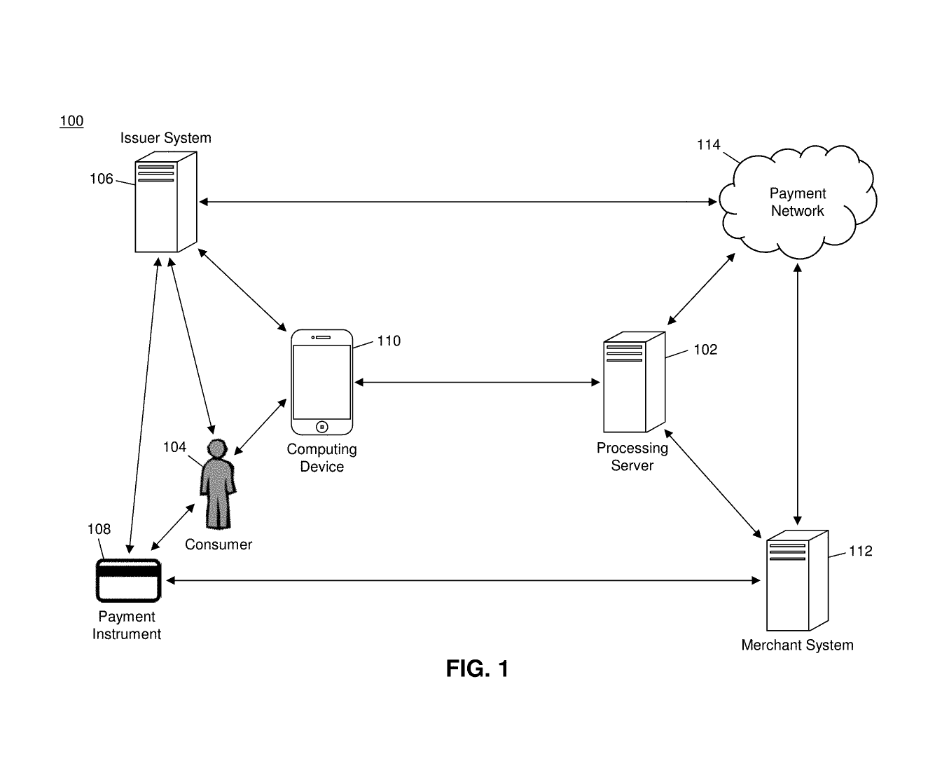

FIG. 1 illustrates a system 100 for the identification of unwanted recurring payment transactions using data tracking algorithms and the notification thereof to an associated consumer.

The system 100 may include a processing server 102. The processing server 102, discussed in more detail below, may be configured to monitor for unwanted recurring payment transactions and to electronically transmit a notification if an unwanted recurring payment transaction is identified to an associated consumer 104. The consumer 104 may be issued a transaction account suitable for use in funding payment transactions by an issuer system 106, which may be a computing system of an issuing financial institution, such as an issuing bank, which may be an entity configured to issue transaction accounts. The consumer 104 may use the transaction account in conducting payment transactions, where the processing server 102 may monitor payment transactions conducted using the issued transaction account to identify unwanted recurring payment transactions.

As part of the issuing of the transaction account to the consumer 104, the issuer system 106 may issue a payment instrument 108 to the consumer 104. The payment instrument 108 may be encoded with or otherwise configured to convey payment credentials associated with the corresponding transaction account. Payment credentials may include, for example, a primary account number, transaction counter, payment cryptograms, etc. The payment instrument 108 may be any suitable type of payment instrument, such as a credit card, check, a computing device 110, etc. Methods for provisioning payment credentials to a computing device 110 will be apparent to persons having skill in the relevant art.

The consumer 104 may use the payment instrument 108 when conducting payment transactions with various merchants. As part of the conducting of a payment transaction, the consumer 104 may present the payment instrument 108 to a merchant system 112 associated with the merchant, which may be any suitable type of computing system, such as a point of sale system. The merchant system 112 may read or otherwise receive the payment credentials from the payment instrument 108.

The merchant system 112 may then submit the payment credentials with other transaction data to a payment network 114 for processing. The other transaction data may include, for example, a transaction amount, transaction time, transaction date, geographic location, product data, merchant data, consumer data, offer data, loyalty data, reward data, issuer data, acquirer data, etc. The transaction data may also include an indication if the payment transaction is a recurring transaction or non-recurring transaction.

In some embodiments, the merchant system 112 may directly submit the transaction data, including the payment credentials, to the payment network 114. In other embodiments, the merchant system 112 may electronically transmit the transaction data with payment credentials to an intermediate entity for forwarding to the payment network 114, such as an acquiring financial institution or gateway processor. The transaction data may be submitted to the payment network 114 via payment rails associated therewith, which may be specialized infrastructure of the payment network 114 used for the exchange of transaction data.

The transaction data may be included in a transaction message. Transaction messages may be specially formatted data messages that are formatted pursuant to one or more standards governing the exchange of financial transaction messages, such as the International Organization of Standardization's ISO 8583 standard. A transaction message may include a message type indicator indicative of a type of the transaction message, such as an authorization request or authorization response. A transaction message may also include a plurality of data elements, each data element being configured to store transaction data, such as a data element configured to store a primary account number, a data element configured to store a transaction amount, a data element configured to store an indication of recurrence of the payment transaction, etc. In some instances, a transaction message may also include one or more bitmaps, which may indicate the data elements included in the transaction message and the transaction data stored therein.

The transaction data submitted to the payment network 114 by, or on behalf of, the merchant system 112 may be stored in the corresponding data elements of a transaction message that includes a message type indicator indicative of an authorization request. The data elements may include at least a first data element configured to store a primary account number associated with the transaction account being used to fund the transaction (e.g., as read from the payment instrument 108), a second data element configured to store a transaction amount, a third data element configured to store a merchant identifier associated with the merchant involved in the transaction, and a fourth data element configured to store an indication if the transaction is a recurring payment transaction. Other data elements may store additional transaction data submitted for the payment transaction, such as a transaction time and a transaction date.

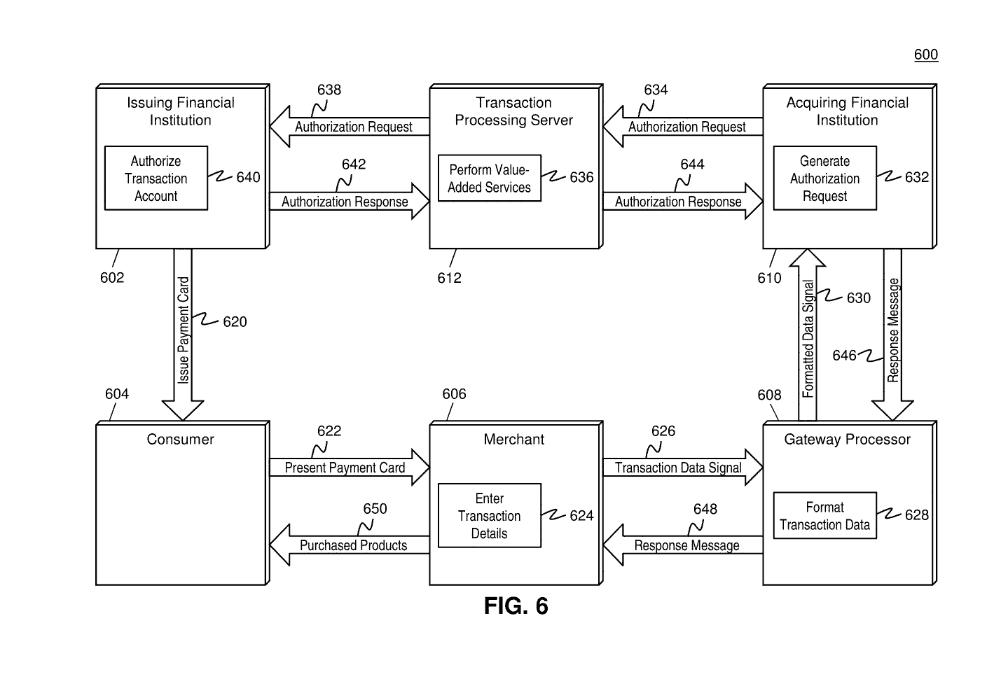

The payment network 114 may be configured to process the payment transaction. Processing of the payment transaction may include the performance of any value-added services, such as fraud scoring, budgeting, account number mapping, etc., and the forwarding of the authorization request to the issuer system 106 via the payment rails associated with the payment network 114. The issuer system 106 may return an authorization response that includes a data element configured to store a response code indicating if the payment transaction is approved or denied to the payment network 114 via the payment rails. The payment network 114 may then forward the authorization response to the merchant system 112 and/or an associated entity for finalization of the payment transaction, which may include, for example, furnishing the transacted-for goods or services to the consumer 104. Additional information regarding the processing of payment transactions is discussed in more detail below with respect to the process 600 illustrated in FIG. 6.

The processing server 102 may be configured to receive authorization requests for recurring payment transactions for the monitoring thereof for identification of unwanted recurring payments using data tracking algorithms as discussed herein. In some embodiments, the processing server 102 may be a part of the payment network 114 and may receive the authorization requests directly from the merchant system 112 or associated entities, or may receive the authorization requests via internal communication networks and methods during processing of the corresponding payment transactions. In other embodiments, the processing server 102 may be external to the payment network 114 and may receive the authorization requests via suitable communication networks, which may include the payment rails associated with the payment network 114.

The processing server 102 may be configured to determine if a payment transaction has a high likelihood of being an unwanted recurring payment, and, if a high likelihood is identified, may electronically transmit a data signal to a computing device 110 associated with the consumer 104 that is superimposed or otherwise encoded with transaction data for the payment transaction to inform the consumer 104 of the recurring payment transaction to provide the consumer 104 with the ability to stop the unwanted recurring payment and cancel future occurrences. The computing device 110 may be any suitable type of computing device, such as a desktop computer, laptop computer, notebook computer, tablet computer, cellular phone, smart phone, smart watch, smart television, wearable computing device, implantable computing device, etc. The processing server 102 may electronically transmit the notification via email, short messaging service message, multimedia messaging service message, a web page, application program, or other suitable communication method to the computing device 110.

To receive notifications for unwanted recurring payments, the consumer 104 may first register with the processing server 102. The consumer 104 may use the computing device 110 to register for the service provided by the processing server 102. As part of the registration, the consumer 104 may provide the primary account number for the transaction account for each transaction account to be monitored by the processing server 102, as well as communication data associated with the computing device 110 for use in receiving the notifications. The communication data may include a communication method and an associated device identifier associated with the computing device 110, such as a telephone number, email address, username, media access control address, internet protocol address, registration number, serial number, etc.

Once the consumer 104 has registered their transaction account, the processing server 102 may electronically transmit a data signal to the payment network 114 and/or issuer system 106 superimposed or otherwise encoded with a data request requesting transaction data entries for past payment transactions funded via the registered transaction account. The processing server 102 may receive the transaction data entries and store them in an account profile associated with the registered transaction account, with each transaction data entry including at least a paid transaction amount, merchant identifier, and indication that if the transaction is a recurring or non-recurring payment transaction. In some instances, each transaction data entry may also include additional transaction data, such as a transaction time and/or date.

When an authorization request for a recurring payment transaction is received by the processing server 102 for the transaction account, the processing server 102 may determine a likelihood of the recurring payment transaction being an unwanted payment transaction. The processing server 102 may determine a high likelihood of an unwanted payment transaction in a plurality of different situations, as discussed in more detail below. For example, in one embodiment, a high likelihood may be identified if the payment transaction is the first occurrence of a recurring payment transaction where the consumer 104 has previously transacted with the merchant for non-recurring payment transactions. In another embodiment, if the transaction is a first occurrence of a recurring payment transaction where the consumer 104 has no history with the merchant and the merchant is identified as a high-risk merchant or is in a high-risk industry, a high likelihood of the recurring payment being unwanted may be identified. High-risk merchants or merchant industries may be identified based on indications of other consumers 104, such as via surveys, questionnaires, volunteered data, prior identifications of unwanted recurring payment transactions, etc. of a merchant and/or merchant industry having a high (e.g., comparatively with other merchants) occurrence of unwanted recurring payment transactions. In yet another embodiment, the processing server 102 may identify a high likelihood of an unwanted recurring payment if the consumer 104 has prior recurring payments to the same merchant, but for a transaction amount that is significantly lower, or if the transaction amount of the recurring payments has steadily increased over a predetermined period of time beyond an acceptable level.

Such algorithms for determining a high likelihood of an unwanted recurring payment transaction may identify occurrences where a merchant that has transacted with a consumer 104 initiates a recurring payment from the consumer 104 without the consumer's present awareness, knowledge or permission. Such algorithms may also identify occurrences where a merchant drastically increases the amount of a recurring payment without the consumer's permission and/or knowledge, or continuously increases the recurring payment amount beyond a level acceptable to the consumer. For example, a yearly increase to a recurring payment by 10% may be acceptable, and known, to a consumer 104, but a new yearly increase for 30% or a change in the increase to every sixth months instead of yearly may be unacceptable. In such examples, the new recurring payment transactions may be identified as unwanted.

When an unwanted recurring payment transaction is identified, the processing server 102 may electronically transmit a data signal to the registered computing device 110 via the selected communication method that is superimposed or otherwise encoded with transaction data parsed from the authorization request for the unwanted recurring payment transaction. The transaction data may include, for example, a transaction amount, merchant identifier, transaction time and/or date, etc. In some instances, the processing server 102 may also provide information related to prior payment transactions involving the merchant, such as to provide reasoning behind identification of the unwanted recurring payment transaction. For example, the notification may indicate an amount and/or period of time of price increase for a continued recurring payment, or may indicate prior non-recurring payments transactions for a merchant now attempting to establish a recurring payment transaction. The consumer 104 may view the notification via a suitable display of the computing device 110, and may then proceed accordingly, such as by confirming that the transaction is wanted by the consumer 104, or by contacting the associated merchant or the consumer's issuing financial institution for stoppage of the recurring payment and cancellation of any future payments.

Methods and systems discussed herein may enable the processing server 102 to automatically identify potentially unwanted recurring payment transactions on behalf of consumers 104. By detecting the unwanted recurring payment transactions automatically, the processing server 102 may enable consumers 104 to have unwanted transactions stopped with significantly less expenditure of time and resources on the part of the consumer 104. In addition, by monitoring authorization requests for payment transactions, the processing server 102 may be able to identify potentially unwanted recurring payment transactions before such transactions are cleared and/or settled, enabling the consumer 104 to stop payment to the merchant before it is made. In addition, the data tracking algorithms utilized by the processing server 102 as discussed herein may enable the processing server 102 to identify the very first recurring payment via data elements included in the authorization request, which may be extremely difficult, or impossible, for a consumer 104 to identify, thus stopping unwanted recurring payments before any payments may be made to the associated merchant. As such, the methods and systems described herein provide for a technological solution to a problem plaguing many consumers 104 by assisting consumers 104 in the identification and notification of unwanted recurring payment transactions.

### Processing Server

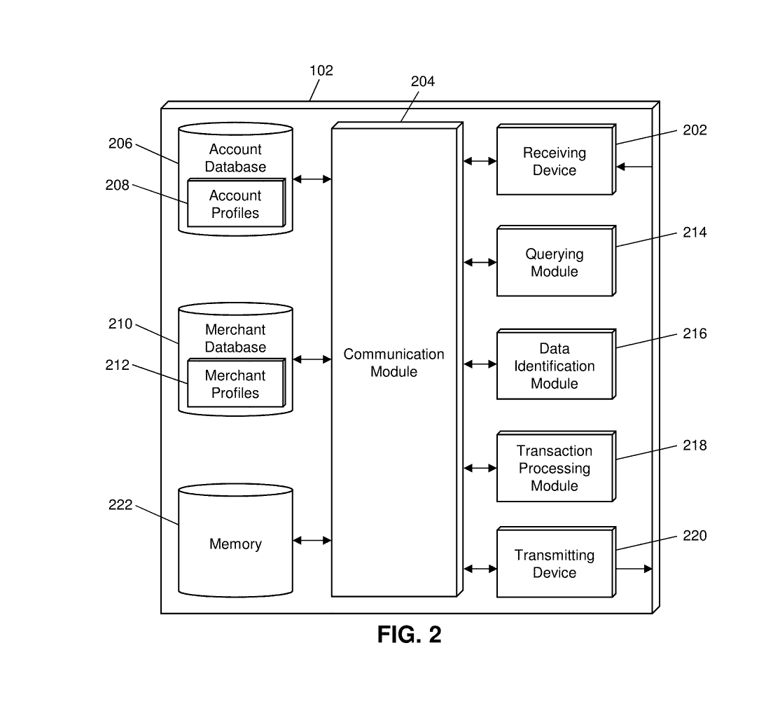

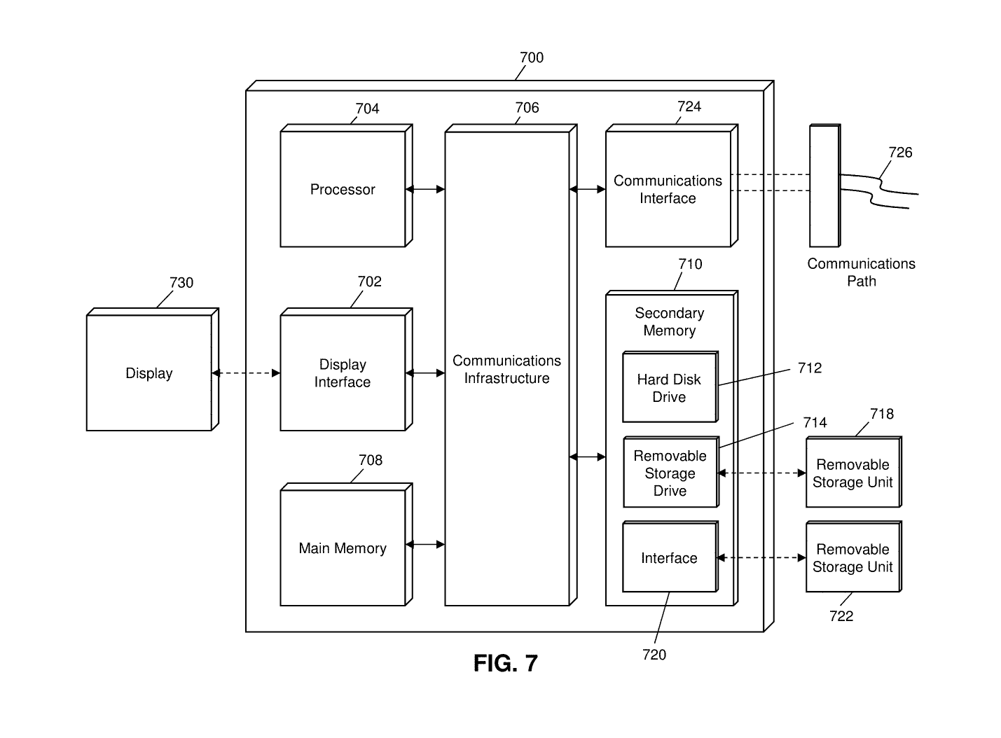

FIG. 2 illustrates an embodiment of the processing server 102 of the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 700 illustrated in FIG. 7 and discussed in more detail below may be a suitable configuration of the processing server 102.

The processing server 102 may include a receiving device 202. The receiving device 202 may be configured to receive data over one or more networks via one or more network protocols. In some embodiments, the receiving device 202 may be configured to receive data over the payment rails, such as using specially configured infrastructure associated with payment networks 114 for the transmission of transaction messages that include sensitive financial data and information. In some instances, the receiving device 202 may also be configured to receive data from issuer systems 106, computing devices 110, merchant systems 112, payment networks 114, and other entities via alternative networks, such as the Internet. In some embodiments, the receiving device 202 may be comprised of multiple devices, such as different receiving devices for receiving data over different networks, such as a first receiving device for receiving data over payment rails and a second receiving device for receiving data over the Internet. The receiving device 202 may receive electronically transmitted data signals, where data may be superimposed or otherwise encoded on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by payment networks 114 that may be superimposed or otherwise encoded with transaction messages. Transaction messages may be formatted pursuant to one or more standards, such as the ISO 8583 standard, and include a message type indicator and a plurality of data elements, such as data elements configured to store primary account numbers, transaction amount, merchant identifiers, and indications of recurring or non-recurring payment transactions. The receiving device 202 may also be configured to receive data signals electronically transmitted by computing devices 110, such as may be superimposed or otherwise encoded with registration data for the registration of a transaction account for the monitoring of unwanted recurring payment transactions.

The processing server 102 may also include a communication module 204. The communication module 204 may be configured to transmit data between modules, engines, databases, memories, and other components of the processing server 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the processing server 102 and external components of the processing server 102, such as externally connected databases, display devices, input devices, etc. The processing server 102 may also include a processing device. The processing device may be configured to perform the functions of the processing server 102 discussed herein as will be apparent to persons having skill in the relevant art. In some embodiments, the processing device may include and/or be comprised of a plurality of engines and/or modules specially configured to perform one or more functions of the processing device, such as a querying module 214, data identification module 216, transaction processing module 218, etc. As used herein, the term “module” may be software or hardware particularly programmed to receive an input, perform one or more processes using the input, and provide an output. The input, output, and processes performed by various modules will be apparent to one skilled in the art based upon the present disclosure.

The processing server 102 may include an account database 206. The account database 206 may be configured to store a plurality of account profiles 208 using a suitable data storage format and schema. The account database 206 may be a relational database that utilizes structured query language for the storage, identification, modifying, updating, accessing, etc. of structured data sets stored therein. Each account profile 208 may be a structured data set configured to store data related to a transaction account. Each account profile 208 may include at least a primary account number corresponding to the related transaction account, communication details associated with a computing device 110 for communication thereto, and a plurality of transaction data entries. Each transaction data entry may include data related to a completed transaction involving the related transaction account including at least a paid amount, merchant identifier, and indication of being a recurring or non-recurring transaction (though recurring transactions can be detected even if this indication is absent to incorrectly identify the nature of the transaction, as described elsewhere herein). In some instances, each transaction data entry may be a transaction message for the related transaction, which may be an authorization request or other suitable type of transaction message, such as a clearing record.

The processing server 102 may also include a merchant database 210. The merchant database 210 may be configured to store a plurality of merchant profiles 212 using a suitable data storage format and schema. The merchant database 210 may be a relational database that utilizes structured query language for the storage, identification, modifying, updating, accessing, etc. of structured data sets stored therein. Each merchant profile 212 may be a structured data set configured to store data related to a high-risk merchant or merchant industry. Each merchant profile 212 may include a merchant identifier corresponding to the related merchant or a merchant category code or other industry identifier corresponding to the related merchant industry. The merchants and/or merchant industries may be a high-risk for attempting to conduct recurring payment transactions unwanted by consumers 104, and may be identified via the methods and systems discussed herein.

The processing server 102 may include a querying module 214. The querying module 214 may be configured to execute queries on databases to identify information. The querying module 214 may receive one or more data values or query strings, and may execute a query string based thereon on an indicated database, such as the account database 206, to identify information stored therein. The querying module 214 may then output the identified information to an appropriate engine or module of the processing server 102 as necessary. The querying module 214 may, for example, execute a query on the account database 206 to identify an account profile 208 related to a transaction account involved in a payment transaction where the included primary account number corresponds to the primary account number stored in a corresponding data element included in a transaction message received by the receiving device 202 for the payment transaction. The querying module 210 may also be configured to execute queries on the account database 206 to identify transaction data entries for past payment transactions involving the associated consumer 104 and the merchant involved in the payment transaction for a received unwanted recurring payment transaction, such as based on the merchant identifier included therein.

The processing server 102 may also include a data identification module 216. The data identification module 216 may receive data and instructions related thereto, may identify data based on the instructions and the received data, and output one or more data values as a result to a suitable module or engine of the processing server 102. The data identification module 216 may be configured to, for example, identify a likelihood of an authorization request (e.g., received via the receiving device 202) being an unwanted recurring payment transaction based on data included therein and the transaction data entries included in a related account profile 208 as identified by the querying module 214. The data identification module 216 may, for instance, identify a high likelihood of an unwanted recurring payment transaction for the first recurring transaction by a consumer 104 with a merchant with no past history of recurring transactions or a high-risk merchant or a merchant in a high-risk industry, or for recurring transactions where the recurring payment amount is significantly higher than previous amounts or has risen a significant amount consistently over a predetermined period of time. The data identification module 216 may detect a recurring payment by data in a data field in authorization or clearance messages for a given transaction. Recurrent transactions can also be detected by noting a similar transaction has occurred in a periodic timeframe such as occurring same day of the month, regular periods (e.g., every four weeks, every few months, every year, etc.) with the same merchant, by looking at past transactions with the same merchant and comparing them against known patterns, by the type of merchant (e.g., a periodical magazine), by key words in the transaction description that might be transmitted with the financial transaction, by identifying merchants that have a high propensity of complaints for grey charges by other consumers in the past via complaint lines, stop payment requests, etc., by identification of a particular merchant or merchants by the card holder who becomes concerned, by databases identifying common price points and payment schedules common to certain types of grey charges (e.g., profiling charge patterns), and other patterns that are known or may emerge over time.

The processing server 102 may also include a transaction processing module 218. The transaction processing module 218 may be configured to perform functions related to the processing of payment transactions. For example, the transaction processing module 218 may be configured to apply fraud rules to a transaction message, determine approval or denial of a payment transaction, apply transaction controls to a payment transaction, swap primary account numbers, adjust data stored in data elements included in a transaction message, identify financial institutions associated with a transaction, forward transaction messages to appropriate entities for further processing, etc. Additional functions that may be performed by the transaction processing module 218 will be apparent to persons having skill in the relevant art.

The processing server 102 may also include a transmitting device 220. The transmitting device 220 may be configured to transmit data over one or more networks via one or more network protocols. In some embodiments, the transmitting device 220 may be configured to transmit data over the payment rails, such as using specially configured infrastructure associated with payment networks 114 for the transmission of transaction messages that include sensitive financial data and information, such as identified payment credentials. In some instances, the transmitting device 220 may be configured to transmit data to issuer systems 106, computing devices 110, merchant systems 112, payment networks 114, and other entities via alternative networks, such as the Internet. In some embodiments, the transmitting device 220 may be comprised of multiple devices, such as different transmitting devices for transmitting data over different networks, such as a first transmitting device for transmitting data over the payment rails and a second transmitting device for transmitting data over the Internet. The transmitting device 220 may electronically transmit data signals that have data superimposed that may be parsed by a receiving computing device. In some instances, the transmitting device 220 may include one or more modules for superimposing, encoding, or otherwise formatting data into data signals suitable for transmission.

The transmitting device 220 may be configured to electronically transmit data signals to payment networks 114 that are superimposed or otherwise encoded with data requests for transaction messages, the data requests including primary account numbers related to transaction accounts for which transaction messages are requested. The transmitting device 220 may also be configured to electronically transmit data signals to computing devices 110 that are superimposed or otherwise encoded with unwanted recurring payment notifications. The notifications may include transaction data parsed from the authorization request for the identified unwanted recurring payment transaction, as well as transaction data parsed from or identified based on data stored in one or more transaction data entries included in a related account profile 208 used in the determination of the payment transaction being an unwanted recurring payment transaction. For instance, a notification may include a reason for determining that the payment transaction is an unwanted payment transaction, such as a statement that the involved merchant is a high-risk merchant.

The processing server 102 may also include a memory 222. The memory 222 may be configured to store data for use by the processing server 102 in performing the functions discussed herein. The memory 222 may be configured to store data using suitable data formatting methods and schema and may be any suitable type of memory, such as read-only memory, random access memory, etc. The memory 222 may include, for example, encryption keys and algorithms, communication protocols and standards, data formatting standards and protocols, program code for modules and application programs of the processing device, and other data that may be suitable for use by the processing server 102 in the performance of the functions disclosed herein as will be apparent to persons having skill in the relevant art. In some embodiments, the memory 222 may be comprised of or may otherwise include a relational database that utilizes structured query language for the storage, identification, modifying, updating, accessing, etc. of structured data sets stored therein.

### Process for Identifying Unwanted Recurring Payment Transactions

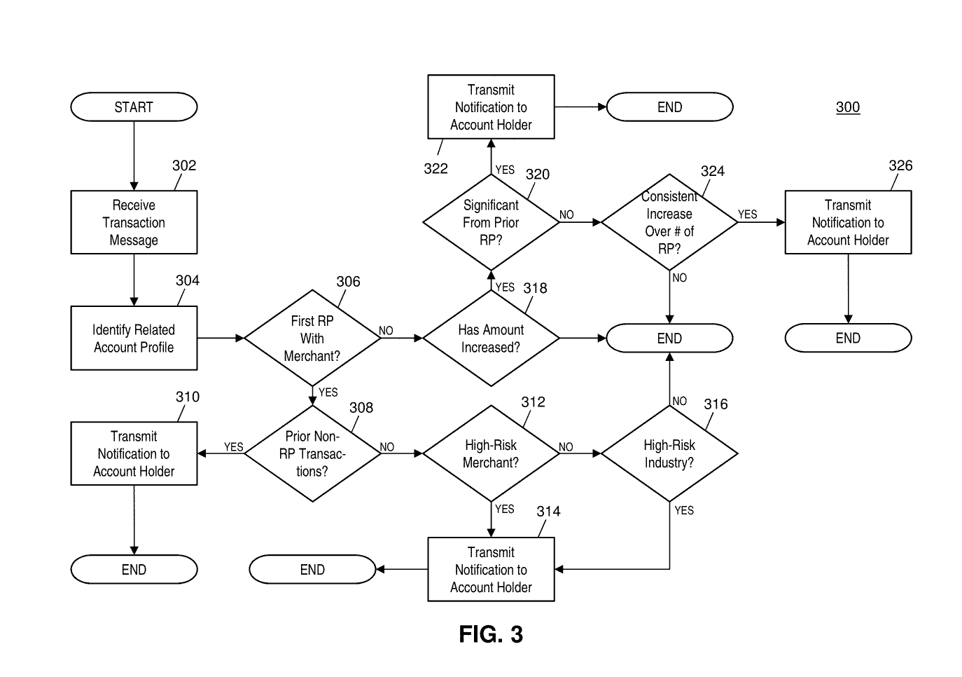

FIG. 3 illustrates a process 300 for the identification of unwanted recurring payment transactions by the processing server 102 and the transmission of notifications thereof to an associated consumer 104.

In step 302, the receiving device 202 of the processing server 102 may receive an authorization request for a recurring payment transaction (RP) from the payment network 114 via the associated payment rails. The authorization request may be a transaction message formatted pursuant to one or more standards, such as the ISO 8583 standard, that includes a message type indicator indicative of an authorization request and a plurality of data elements including at least a first data element configured to store a primary account number, a second data element configured to store a transaction amount, a third data element configured to store a merchant identifier, a fourth data element configured to store an indication of a recurring payment transaction (which is either provided by the merchant or inserted by the data identification module 216), and a fifth data element configured to store a merchant category code.

In step 304, the querying module 214 of the processing server 102 may execute a query on the account database 206 of the processing server 102 to identify an account profile 208 related to the recurring payment transaction, where the included primary account number corresponds to the primary account number stored in the first data element included in the received authorization request. In step 306, the data identification module 216 of the processing server 102 may determine if the recurring payment transaction is the first recurring payment transaction involving the transaction account related to the identified account profile 208 and the merchant involved in the payment transaction. The determination may be based on a querying (e.g., via the querying module 214) of the transaction data entries stored in the identified account profile 208 to identify that there are no transaction data entries included in the account profile 208 that include the merchant identifier stored in the third data element included in the authorization request and that are indicated as being a recurring payment transaction, as explained above.

If the data identification module 216 determines that the authorization request is for the first recurring payment transaction involving the transaction account and merchant, then, in step 308, the data identification module 216 may determine if the transaction account and merchant have transacted via any prior non-recurring payment transactions. The determination may be based on a query of the transaction data entries stored in the account profile 208 to identify if there are any transaction data entries stored in the identified account profile 208 that include the merchant identified stored in the third data element included in the authorization request and that are indicated as being a non-recurring payment transaction. If any such transactions are identified, then, in step 310, the transmitting device 220 of the processing server 102 may electronically transmit a data signal to the computing device 110 associated with the identified account profile 208, based on the communication data included therein, that is superimposed or otherwise encoded with a notification regarding the recurring payment transactions. In some embodiments, a reason may be provided in the notification, such as, based on the determination in step 308, that a prior transaction between the related consumer 104 and merchant has triggered a recurring payment transaction, potentially without the consumer's knowledge.

If, in step 308, the data identification module 216 does not identify any prior non-recurring payment transactions, such that the recurring payment transaction is the first transaction of any kind with the merchant, then, in step 312, the data identification module 216 may determine if the involved merchant is a high risk merchant. The identification may be based on a query (e.g., via the querying module 214) of the merchant database 210 to identify if there is a merchant profile 212 that is related to high-risk merchants that includes the merchant identifier stored in the third data element included in the received authorization request. If the merchant is a high-risk merchant, then, in step 314, the transmitting device 220 of the processing server 102 may electronically transmit the data signal superimposed or otherwise encoded with the notification to the computing device 110 associated with the identified account profile 208.

If, in step 312, the data identification module 216 of the processing server 102 does not identify the involved merchant as a high risk merchant, then, in step 316, the data identification module 216 may determine if the merchant belongs to a high-risk industry. The determination may be based on a query (e.g., via the querying module 214) of the merchant database 210 to identify a merchant profile 212 that is related to a high-risk merchant industry that includes the merchant category code stored in the fifth data element included in the received authorization request. If the merchant belongs to a high-risk industry as indicated via the merchant category code, then the process 300 may proceed to step 314 where the transmitting device 220 electronically transmits the notification to the computing device 110. If the merchant does not belong to a high-risk industry, then the process 300 may be completed as the processing server 102 may determine a low likelihood that the recurring payment transaction is an unwanted transaction.

If the recurring payment transaction is not the first recurring payment transaction between the involved transaction account and merchant, as determined by the data identification module 216 in step 306, then the process 300 may proceed to step 318. In step 318, the data identification module 216 may determine if the recurring payment amount has increased over previous recurring payments, which may be based on the transaction amount stored in the second data element included in the received authorization request and the paid amount included in the transaction data entries for one or more prior payment transactions in the identified account profile 208 that include the merchant identifier stored in the third data element included in the received authorization request and are indicated as being recurring payment transactions. If the transaction amount for the new recurring payment transaction has not increased over prior amounts, then the process 300 may be completed as the processing server 102 may determine a low likelihood that the recurring payment transaction is an unwanted transaction.

If, in step 318, the data identification module 216 determines that the transaction amount has increased for the new recurring payment transaction over prior recurring payments to the merchant, then, in step 320, the data identification module 216 may determine if the increase is significant compared to the most recently completed recurring payment transaction. The data identification module 216 may identify (e.g., via the querying module 214) the most recent recurring payment transaction stored in the identified account profile 208 as a transaction data entry via a transaction date included therein, and may compare the paid amount included therein to the transaction amount stored in the second data element included in the received authorization request. If the transaction amount is a predetermined amount higher than the paid amount, then the increase may be considered significant, and, in step 322, the transmitting device 220 of the processing server 102 may electronically transmit the notification of the unwanted recurring payment transaction to the computing device 110 associated with the identified account profile 208. The predetermined amount may be set by the processing server 102, consumer 104 (e.g., during registration), or other suitable entity. The predetermined amount may be a number value (e.g., $30), may be a percentage (e.g., 30%), or may be any other suitable representation related to transaction amounts.

If, in step 320, the data identification module 216 determines that the increase since the most recent completed recurring payment transaction is not significant, then, in step 322, the data identification module 216 may determine if there has been an unwanted, consistent increase in the transaction amount for prior recurring payments involving the merchant. The determination may be based on the paid amounts included in prior recurring payment transactions as indicated by the data stored in corresponding transaction data entries included in the identified account profile 208. A consistent increase may be based on a predetermined amount of increase (e.g., $30, 30%, etc.) over a period of time (e.g., one month, six months, one year, etc.) and/or over a number of recurring payment transactions (e.g., three, four, five, etc.). The predetermined amounts and periods of time or numbers of transactions may be set by the processing server 102, the consumer 104 (e.g., during registration), or other suitable entity. If there is a consistent increase, then, in step 326, the transmitting device 220 of the processing server 102 may electronically transmit the notification of the unwanted recurring payment transaction to the computing device 110 associated with the identified account profile 208. If there is no consistent increase (e.g., it is a single, annual increase), then the process 300 may be completed as the processing server 102 may determine a low likelihood that the recurring payment transaction is an unwanted transaction.

### First Exemplary Method for Monitoring for Unwanted Recurring Transactions

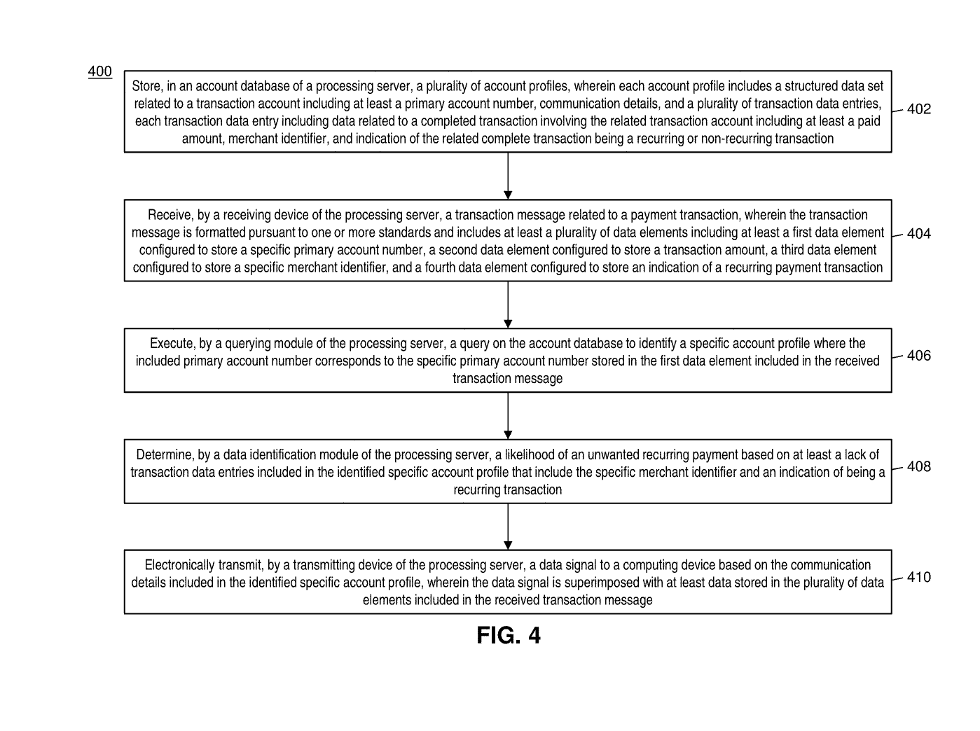

FIG. 4 illustrates a method 400 for the monitoring of unwanted recurring payment transactions for payment transactions involving a consumer and a merchant with no prior history of recurring payment transactions.

In step 402, a plurality of account profiles (e.g., account profiles 208) may be stored in an account database (e.g., the account database 206) of a processing server (e.g., the processing server 102), wherein each account profile includes a structured data set related to a transaction account including at least a primary account number, communication details, and a plurality of transaction data entries, each transaction data entry including data related to a completed transaction involving the related transaction account including at least a paid amount, merchant identifier, and indication of the related complete transaction being a recurring or non-recurring transaction. In step 404, a transaction message related to a payment transaction may be received by a receiving device (e.g., the receiving device 202) of the processing server, wherein the transaction message is formatted pursuant to one or more standards and includes at least a plurality of data elements including at least a first data element configured to store a specific primary account number, a second data element configured to store a transaction amount, a third data element configured to store a specific merchant identifier, and a fourth data element configured to store an indication of a recurring payment transaction.

In step 406, a query may be executed by a querying module (e.g., the querying module 214) of the processing server on the account database to identify a specific account profile where the included primary account number corresponds to the specific primary account number stored in the first data element included in the received transaction message. In step 408, a likelihood of an unwanted recurring payment transaction may be determined by a data identification module (e.g., the data identification module 216) of the processing server based on at least a lack of transaction data entries included in the identified specific account profile that include the specific merchant identifier and an indication of being a recurring transaction (which might be inserted into the transaction data if a recurring payment is recognized as explained above, by the data identification module 216). In step 410, a data signal may be electronically transmitted by a transmitting device (e.g., the transmitting device 220) of the processing server to a computing device (e.g., the computing device 110) based on the communication details included in the identified specific account profile, wherein the data signal is superimposed with at least data stored in the plurality of data elements included in the received transaction message.

In one embodiment, the likelihood of an unwanted recurring payment may be further based on the inclusion of at least one transaction data entry included in the identified specific account profile that includes the specific merchant identifier and an indication of being a non-recurring transaction. In some embodiments, the method 400 may further include storing, in a merchant database (e.g., the merchant database 210), a plurality of merchant profiles (e.g., merchant profiles 212), wherein each merchant profile includes a structured data set related to one or more high-risk merchants including at least an associated merchant identifier, wherein the likelihood of an unwanted recurring payment is further based on the inclusion of the specific merchant identifier stored in the third data element included in the received transaction message in at least one merchant profile stored in the merchant database. In a further embodiment, the likelihood of an unwanted recurring payment may be even further based on a lack of transaction data entries included in the identified specific account profile that include the specific merchant identifier and an indication of being a non-recurring transaction. In one embodiment, the merchant identifier may be one of: a merchant identification number and a merchant category code.

### Second Exemplary Method for Monitoring for Unwanted Recurring Transactions

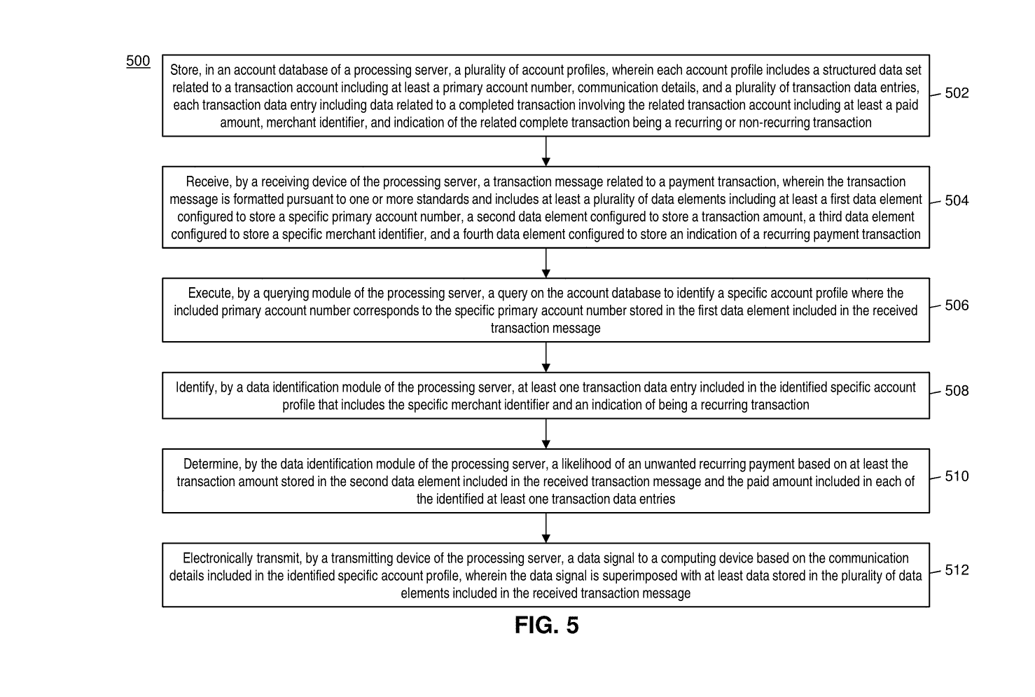

FIG. 5 illustrates a method 500 for the monitoring of unwanted recurring payment transactions for payment transactions involving a consumer and a merchant with prior history of recurring payment transactions.

In step 502, a plurality of account profiles (e.g., account profiles 208) may be stored in an account database (e.g., the account database 206) of a processing server (e.g., the processing server 102), wherein each account profile includes a structured data set related to a transaction account including at least a primary account number, communication details, and a plurality of transaction data entries, each transaction data entry including data related to a completed transaction involving the related transaction account including at least a paid amount, merchant identifier, and indication of the related complete transaction being a recurring or non-recurring transaction. In step 504, a transaction message related to a payment transaction may be received by a receiving device (e.g., the receiving device 202) of the processing server, wherein the transaction message is formatted pursuant to one or more standards and includes at least a plurality of data elements including at least a first data element configured to store a specific primary account number, a second data element configured to store a transaction amount, a third data element configured to store a specific merchant identifier, and a fourth data element configured to store an indication of a recurring payment transaction.

In step 506, a query may be executed by a querying module (e.g., the querying module 214) of the processing server on the account database to identify a specific account profile where the included primary account number corresponds to the specific primary account number stored in the first data element included in the received transaction message. In step 508, at least one transaction data entry included in the identified specific account profile may be identified by a data identification module (e.g., the data identification module 216) of the processing server that includes the specific merchant identifier and an indication of being a recurring transaction.

In step 510, a likelihood of an unwanted recurring payment transaction may be determined by the data identification module of the processing server based on at least the transaction amount stored in the second data element included in the received transaction message and the paid amount included in each of the identified at least one transaction data entries. In step 512, a data signal may be electronically transmitted by a transmitting device (e.g., the transmitting device 220) of the processing server to a computing device (e.g., the computing device 110) based on the communication details included in the identified specific account profile, wherein the data signal is superimposed with at least data stored in the plurality of data elements included in the received transaction message.

In one embodiment, each transaction data entry may further include a transaction date, and the likelihood of an unwanted recurring payment may be further based on the paid amount included in a specific transaction data entry of the identified at least one transaction data entries being of a predetermined amount less than the transaction amount stored in the second data element included in the received transaction message, wherein the specific transaction data entry may include a transaction date more recent than the transaction date included in each other transaction data entry included in the identified at least one transaction data entries. In a further embodiment, the predetermined amount may be thirty percent.

In some embodiments, each transaction data entry may further include a transaction date, the data identification module may identify two or more transaction data entries that include the specific merchant identifier and an indication of being a recurring transaction, and the likelihood of an unwanted recurring payment transaction may be further based on a consistent increase in the paid amount included in a predetermined number of the identified two or more transaction data entries based on the paid amount and transaction date included in the identified two or more transaction data entries. In a further embodiment, the consistent increase may be an increase in the paid amount by at least a predetermined amount.

### Payment Transaction Processing System and Process

FIG. 6 illustrates a transaction processing system and a process 600 for the processing of payment transactions in the system, which may include the processing of thousands, millions, or even billions of transactions during a given period (e.g., hourly, daily, weekly, etc.). The process 600 and steps included therein may be performed by one or more components of the system 100 discussed above, such as the processing server 102, consumer 104, issuer system 106, payment instrument 108, computing device 110, merchant system 112, payment network 114, etc. The processing of payment transactions using the system and process 600 illustrated in FIG. 6 and discussed below may utilize the payment rails, which may be comprised of the computing devices and infrastructure utilized to perform the steps of the process 600 as specially configured and programmed by the entities discussed below, including the transaction processing server 612, which may be associated with one or more payment networks configured to processing payment transactions. It will be apparent to persons having skill in the relevant art that the process 600 may be incorporated into the processes illustrated in FIGS. 3-5, discussed above, with respect to the step or steps involved in the processing of a payment transaction. In addition, the entities discussed herein for performing the process 600 may include one or more computing devices or systems configured to perform the functions discussed below. For instance, the merchant 606 may be comprised of one or more point of sale devices, a local communication network, a computing server, and other devices configured to perform the functions discussed below.

In step 620, an issuing financial institution 602 may issue a payment card or other suitable payment instrument to a consumer 604. The issuing financial institution may be a financial institution, such as a bank, or other suitable type of entity that administers and manages payment accounts and/or payment instruments for use with payment accounts that can be used to fund payment transactions. The consumer 604 may have a transaction account with the issuing financial institution 602 for which the issued payment card is associated, such that, when used in a payment transaction, the payment transaction is funded by the associated transaction account. In some embodiments, the payment card may be issued to the consumer 604 physically. In other embodiments, the payment card may be a virtual payment card or otherwise provisioned to the consumer 604 in an electronic format.

In step 622, the consumer 604 may present the issued payment card to a merchant 606 for use in funding a payment transaction. The merchant 606 may be a business, another consumer, or any entity that may engage in a payment transaction with the consumer 604. The payment card may be presented by the consumer 604 via providing the physical card to the merchant 606, electronically transmitting (e.g., via near field communication, wireless transmission, or other suitable electronic transmission type and protocol) payment details for the payment card, or initiating transmission of payment details to the merchant 606 via a third party. The merchant 606 may receive the payment details (e.g., via the electronic transmission, via reading them from a physical payment card, etc.), which may include at least a transaction account number associated with the payment card and/or associated transaction account. In some instances, the payment details may include one or more application cryptograms, which may be used in the processing of the payment transaction.

In step 624, the merchant 606 may enter transaction details into a point of sale computing system. The transaction details may include the payment details provided by the consumer 604 associated with the payment card and additional details associated with the transaction, such as a transaction amount, time and/or date, product data, offer data, loyalty data, reward data, merchant data, consumer data, point of sale data, etc. Transaction details may be entered into the point of sale system of the merchant 606 via one or more input devices, such as an optical bar code scanner configured to scan product bar codes, a keyboard configured to receive product codes input by a user, etc. The merchant point of sale system may be a specifically configured computing device and/or special purpose computing device intended for the purpose of processing electronic financial transactions and communicating with a payment network (e.g., via the payment rails). The merchant point of sale system may be an electronic device upon which a point of sale system application is run, wherein the application causes the electronic device to receive and communicated electronic financial transaction information to a payment network. In some embodiments, the merchant 606 may be an online retailer in an e-commerce transaction. In such embodiments, the transaction details may be entered in a shopping cart or other repository for storing transaction data in an electronic transaction as will be apparent to persons having skill in the relevant art.

In step 626, the merchant 606 may electronically transmit a data signal superimposed with transaction data to a gateway processor 608. The gateway processor 608 may be an entity configured to receive transaction details from a merchant 606 for formatting and transmission to an acquiring financial institution 610. In some instances, a gateway processor 608 may be associated with a plurality of merchants 606 and a plurality of acquiring financial institutions 610. In such instances, the gateway processor 608 may receive transaction details for a plurality of different transactions involving various merchants, which may be forwarded on to appropriate acquiring financial institutions 610. By having relationships with multiple acquiring financial institutions 610 and having the requisite infrastructure to communicate with financial institutions using the payment rails, such as using application programming interfaces associated with the gateway processor 608 or financial institutions used for the submission, receipt, and retrieval of data, a gateway processor 608 may act as an intermediary for a merchant 606 to be able to conduct payment transactions via a single communication channel and format with the gateway processor 608, without having to maintain relationships with multiple acquiring financial institutions 610 and payment processors and the hardware associated thereto. Acquiring financial institutions 610 may be financial institutions, such as banks, or other entities that administers and manages payment accounts and/or payment instruments for use with payment accounts. In some instances, acquiring financial institutions 610 may manage transaction accounts for merchants 606. In some cases, a single financial institution may operate as both an issuing financial institution 602 and an acquiring financial institution 610.

The data signal transmitted from the merchant 606 to the gateway processor 608 may be superimposed with the transaction details for the payment transaction, which may be formatted based on one or more standards. In some embodiments, the standards may be set forth by the gateway processor 608, which may use a unique, proprietary format for the transmission of transaction data to/from the gateway processor 608. In other embodiments, a public standard may be used, such as the International Organization for Standardization's ISO 8683 standard. The standard may indicate the types of data that may be included, the formatting of the data, how the data is to be stored and transmitted, and other criteria for the transmission of the transaction data to the gateway processor 608.

In step 628, the gateway processor 608 may parse the transaction data signal to obtain the transaction data superimposed thereon and may format the transaction data as necessary. The formatting of the transaction data may be performed by the gateway processor 608 based on the proprietary standards of the gateway processor 608 or an acquiring financial institution 610 associated with the payment transaction. The proprietary standards may specify the type of data included in the transaction data and the format for storage and transmission of the data. The acquiring financial institution 610 may be identified by the gateway processor 608 using the transaction data, such as by parsing the transaction data (e.g., deconstructing into data elements) to obtain an account identifier included therein associated with the acquiring financial institution 610. In some instances, the gateway processor 608 may then format the transaction data based on the identified acquiring financial institution 610, such as to comply with standards of formatting specified by the acquiring financial institution 610. In some embodiments, the identified acquiring financial institution 610 may be associated with the merchant 606 involved in the payment transaction, and, in some cases, may manage a transaction account associated with the merchant 606.

In step 630, the gateway processor 608 may electronically transmit a data signal superimposed with the formatted transaction data to the identified acquiring financial institution 610. The acquiring financial institution 610 may receive the data signal and parse the signal to obtain the formatted transaction data superimposed thereon. In step 632, the acquiring financial institution may generate an authorization request for the payment transaction based on the formatted transaction data. The authorization request may be a specially formatted transaction message that is formatted pursuant to one or more standards, such as the ISO 8683 standard and standards set forth by a payment processor used to process the payment transaction, such as a payment network. The authorization request may be a transaction message that includes a message type indicator indicative of an authorization request, which may indicate that the merchant 606 involved in the payment transaction is requesting payment or a promise of payment from the issuing financial institution 602 for the transaction. The authorization request may include a plurality of data elements, each data element being configured to store data as set forth in the associated standards, such as for storing an account number, application cryptogram, transaction amount, issuing financial institution 602 information, etc.

In step 634, the acquiring financial institution 610 may electronically transmit the authorization request to a transaction processing server 612 for processing. The transaction processing server 612 may be comprised of one or more computing devices as part of a payment network configured to process payment transactions. In some embodiments, the authorization request may be transmitted by a transaction processor at the acquiring financial institution 610 or other entity associated with the acquiring financial institution. The transaction processor may be one or more computing devices that include a plurality of communication channels for communication with the transaction processing server 612 for the transmission of transaction messages and other data to and from the transaction processing server 612. In some embodiments, the payment network associated with the transaction processing server 612 may own or operate each transaction processor such that the payment network may maintain control over the communication of transaction messages to and from the transaction processing server 612 for network and informational security.

In step 636, the transaction processing server 612 may perform value-added services for the payment transaction. Value-added services may be services specified by the issuing financial institution 602 that may provide additional value to the issuing financial institution 602 or the consumer 604 in the processing of payment transactions. Value-added services may include, for example, fraud scoring, transaction or account controls, account number mapping, offer redemption, loyalty processing, etc. For instance, when the transaction processing server 612 receives the transaction, a fraud score for the transaction may be calculated based on the data included therein and one or more fraud scoring algorithms and/or engines. In some instances, the transaction processing server 612 may first identify the issuing financial institution 602 associated with the transaction, and then identify any services indicated by the issuing financial institution 602 to be performed. The issuing financial institution 602 may be identified, for example, by data included in a specific data element included in the authorization request, such as an issuer identification number. In another example, the issuing financial institution 602 may be identified by the primary account number stored in the authorization request, such as by using a portion of the primary account number (e.g., a bank identification number) for identification.

In step 638, the transaction processing server 612 may electronically transmit the authorization request to the issuing financial institution 602. In some instances, the authorization request may be modified, or additional data included in or transmitted accompanying the authorization request as a result of the performance of value-added services by the transaction processing server 612. In some embodiments, the authorization request may be transmitted to a transaction processor (e.g., owned or operated by the transaction processing server 612) situated at the issuing financial institution 602 or an entity associated thereof, which may forward the authorization request to the issuing financial institution 602.

In step 640, the issuing financial institution 602 may authorize the transaction account for payment of the payment transaction. The authorization may be based on an available credit amount for the transaction account and the transaction amount for the payment transaction, fraud scores provided by the transaction processing server 612, and other considerations that will be apparent to persons having skill in the relevant art. The issuing financial institution 602 may modify the authorization request to include a response code indicating approval (e.g., or denial if the transaction is to be denied) of the payment transaction. The issuing financial institution 602 may also modify a message type indicator for the transaction message to indicate that the transaction message is changed to be an authorization response. In step 642, the issuing financial institution 602 may transmit (e.g., via a transaction processor) the authorization response to the transaction processing server 612.

In step 644, the transaction processing server 612 may forward the authorization response to the acquiring financial institution 610 (e.g., via a transaction processor). In step 646, the acquiring financial institution may generate a response message indicating approval or denial of the payment transaction as indicated in the response code of the authorization response, and may transmit the response message to the gateway processor 608 using the standards and protocols set forth by the gateway processor 608. In step 648, the gateway processor 608 may forward the response message to the merchant 606 using the appropriate standards and protocols. In step 660, assuming the transaction was approved, the merchant 606 may then provide the products purchased by the consumer 604 as part of the payment transaction to the consumer 604.

In some embodiments, once the process 600 has completed, payment from the issuing financial institution 602 to the acquiring financial institution 610 may be performed. In some instances, the payment may be made immediately or within one business day. In other instances, the payment may be made after a period of time, and in response to the submission of a clearing request from the acquiring financial institution 610 to the issuing financial institution 602 via the transaction processing server 602. In such instances, clearing requests for multiple payment transactions may be aggregated into a single clearing request, which may be used by the transaction processing server 612 to identify overall payments to be made by whom and to whom for settlement of payment transactions.

In some instances, the system may also be configured to perform the processing of payment transactions in instances where communication paths may be unavailable. For example, if the issuing financial institution is unavailable to perform authorization of the transaction account (e.g., in step 640), the transaction processing server 612 may be configured to perform authorization of transactions on behalf of the issuing financial institution 602. Such actions may be referred to as “stand-in processing,” where the transaction processing server “stands in” as the issuing financial institution 602. In such instances, the transaction processing server 612 may utilize rules set forth by the issuing financial institution 602 to determine approval or denial of the payment transaction, and may modify the transaction message accordingly prior to forwarding to the acquiring financial institution 610 in step 644. The transaction processing server 612 may retain data associated with transactions for which the transaction processing server 612 stands in, and may transmit the retained data to the issuing financial institution 602 once communication is reestablished. The issuing financial institution 602 may then process transaction accounts accordingly to accommodate for the time of lost communication.

In another example, if the transaction processing server 612 is unavailable for submission of the authorization request by the acquiring financial institution 610, then the transaction processor at the acquiring financial institution 610 may be configured to perform the processing of the transaction processing server 612 and the issuing financial institution 602. The transaction processor may include rules and data suitable for use in making a determination of approval or denial of the payment transaction based on the data included therein. For instance, the issuing financial institution 602 and/or transaction processing server 612 may set limits on transaction type, transaction amount, etc. that may be stored in the transaction processor and used to determine approval or denial of a payment transaction based thereon. In such instances, the acquiring financial institution 610 may receive an authorization response for the payment transaction even if the transaction processing server 612 is unavailable, ensuring that transactions are processed and no downtime is experienced even in instances where communication is unavailable. In such cases, the transaction processor may store transaction details for the payment transactions, which may be transmitted to the transaction processing server 612 (e.g., and from there to the associated issuing financial institutions 602) once communication is reestablished.

In some embodiments, transaction processors may be configured to include a plurality of different communication channels, which may utilize multiple communication cards and/or devices, to communicate with the transaction processing server 612 for the sending and receiving of transaction messages. For example, a transaction processor may be comprised of multiple computing devices, each having multiple communication ports that are connected to the transaction processing server 612. In such embodiments, the transaction processor may cycle through the communication channels when transmitting transaction messages to the transaction processing server 612, to alleviate network congestion and ensure faster, smoother communications. Furthermore, in instances where a communication channel may be interrupted or otherwise unavailable, alternative communication channels may thereby be available, to further increase the uptime of the network.

In some embodiments, transaction processors may be configured to communicate directly with other transaction processors. For example, a transaction processor at an acquiring financial institution 610 may identify that an authorization request involves an issuing financial institution 602 (e.g., via the bank identification number included in the transaction message) for which no value-added services are required. The transaction processor at the acquiring financial institution 610 may then transmit the authorization request directly to the transaction processor at the issuing financial institution 602 (e.g., without the authorization request passing through the transaction processing server 612), where the issuing financial institution 602 may process the transaction accordingly.

The methods discussed above for the processing of payment transactions that utilize multiple methods of communication using multiple communication channels, and includes fail safes to provide for the processing of payment transactions at multiple points in the process and at multiple locations in the system, as well as redundancies to ensure that communications arrive at their destination successfully even in instances of interruptions, may provide for a robust system that ensures that payment transactions are always processed successfully with minimal error and interruption. This advanced network and its infrastructure and topology may be commonly referred to as “payment rails,” where transaction data may be submitted to the payment rails from merchants at millions of different points of sale, to be routed through the infrastructure to the appropriate transaction processing servers 612 for processing. The payment rails may be such that a general purpose computing device may be unable to properly format or submit communications to the rails, without specialized programming and/or configuration. Through the specialized purposing of a computing device, the computing device may be configured to submit transaction data to the appropriate entity (e.g., a gateway processor 608, acquiring financial institution 610, etc.) for processing using this advanced network, and to quickly and efficiently receive a response regarding the ability for a consumer 604 to fund the payment transaction.

### Computer System Architecture

FIG. 7 illustrates a computer system 700 in which embodiments of the present disclosure, or portions thereof, may be implemented as computer-readable code. For example, the processing server 102 of FIG. 1 may be implemented in the computer system 700 using hardware, software, firmware, non-transitory computer readable media having instructions stored thereon, or a combination thereof and may be implemented in one or more computer systems or other processing systems.

Hardware, software, or any combination thereof may embody modules and components used to implement the methods of FIGS. 3-6.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 718, a removable storage unit 722, and a hard disk installed in hard disk drive 712.

Various embodiments of the present disclosure are described in terms of this example computer system 700. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 704 may be a special purpose or a general purpose processor device specifically configured to perform the functions discussed herein. The processor device 704 may be connected to a communications infrastructure 706, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 700 may also include a main memory 708 (e.g., random access memory, read-only memory, etc.), and may also include a secondary memory 710. The secondary memory 710 may include the hard disk drive 712 and a removable storage drive 714, such as a floppy disk drive, a magnetic tape drive, an optical disk drive, a flash memory, etc.

The removable storage drive 714 may read from and/or write to the removable storage unit 718 in a well-known manner. The removable storage unit 718 may include a removable storage media that may be read by and written to by the removable storage drive 714. For example, if the removable storage drive 714 is a floppy disk drive or universal serial bus port, the removable storage unit 718 may be a floppy disk or portable flash drive, respectively. In one embodiment, the removable storage unit 718 may be non-transitory computer readable recording media.

In some embodiments, the secondary memory 710 may include alternative means for allowing computer programs or other instructions to be loaded into the computer system 700, for example, the removable storage unit 722 and an interface 720. Examples of such means may include a program cartridge and cartridge interface (e.g., as found in video game systems), a removable memory chip (e.g., EEPROM, PROM, etc.) and associated socket, and other removable storage units 722 and interfaces 720 as will be apparent to persons having skill in the relevant art.

Data stored in the computer system 700 (e.g., in the main memory 708 and/or the secondary memory 710) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 700 may also include a communications interface 724. The communications interface 724 may be configured to allow software and data to be transferred between the computer system 700 and external devices. Exemplary communications interfaces 724 may include a modem, a network interface (e.g., an Ethernet card), a communications port, a PCMCIA slot and card, etc. Software and data transferred via the communications interface 724 may be in the form of signals, which may be electronic, electromagnetic, optical, or other signals as will be apparent to persons having skill in the relevant art. The signals may travel via a communications path 726, which may be configured to carry the signals and may be implemented using wire, cable, fiber optics, a phone line, a cellular phone link, a radio frequency link, etc.

The computer system 700 may further include a display interface 702. The display interface 702 may be configured to allow data to be transferred between the computer system 700 and external display 730. Exemplary display interfaces 702 may include high-definition multimedia interface (HDMI), digital visual interface (DVI), video graphics array (VGA), etc. The display 730 may be any suitable type of display for displaying data transmitted via the display interface 702 of the computer system 700, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 708 and secondary memory 710, which may be memory semiconductors (e.g., DRAMs, etc.). These computer program products may be means for providing software to the computer system 700. Computer programs (e.g., computer control logic) may be stored in the main memory 708 and/or the secondary memory 710. Computer programs may also be received via the communications interface 724. Such computer programs, when executed, may enable computer system 700 to implement the present methods as discussed herein. In particular, the computer programs, when executed, may enable processor device 704 to implement the methods illustrated by FIGS. 3-6, as discussed herein. Accordingly, such computer programs may represent controllers of the computer system 700. Where the present disclosure is implemented using software, the software may be stored in a computer program product and loaded into the computer system 700 using the removable storage drive 714, interface 720, and hard disk drive 712, or communications interface 724.

The processor device 704 may comprise one or more modules or engines configured to perform the functions of the computer system 700. Each of the modules or engines may be implemented using hardware and, in some instances, may also utilize software, such as corresponding to program code and/or programs stored in the main memory 708 or secondary memory 710. In such instances, program code may be compiled by the processor device 704 (e.g., by a compiling module or engine) prior to execution by the hardware of the computer system 700. For example, the program code may be source code written in a programming language that is translated into a lower level language, such as assembly language or machine code, for execution by the processor device 704 and/or any additional hardware components of the computer system 700. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 700 to perform the functions disclosed herein. It will be apparent to persons having skill in the relevant art that such processes result in the computer system 700 being a specially configured computer system 700 uniquely programmed to perform the functions discussed above.

Techniques consistent with the present disclosure provide, among other features, systems and methods for monitoring for unwanted recurring transactions. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for monitoring for unwanted recurring transactions, comprising:
storing, in an account database of a processing server, a plurality of account profiles, wherein each account profile includes a structured data set related to a transaction account including at least a primary account number, communication details, and a plurality of transaction data entries, each transaction data entry including data related to a completed transaction involving the related transaction account including at least a paid amount, merchant identifier, and indication of the related complete transaction being a recurring or non-recurring transaction;
receiving, by a receiving device of the processing server, a transaction message related to a payment transaction, wherein the transaction message is formatted pursuant to one or more standards and includes at least a plurality of data elements including at least a first data element configured to store a specific primary account number, a second data element configured to store a transaction amount, a third data element configured to store a specific merchant identifier, and a fourth data element configured to store an indication of a recurring payment transaction;
executing, by a querying module of the processing server, a query on the account database to identify a specific account profile where the included primary account number corresponds to the specific primary account number stored in the first data element included in the received transaction message;
determining, by a data identification module of the processing server, a likelihood of an unwanted recurring payment based on at least a lack of transaction data entries included in the identified specific account profile that include the specific merchant identifier and an indication of being a recurring transaction; and
electronically transmitting, by a transmitting device of the processing server, a data signal to a computing device based on the communication details included in the identified specific account profile, wherein the data signal is superimposed with at least data stored in the plurality of data elements included in the received transaction message.

2. The method of claim 1, wherein the likelihood of an unwanted recurring payment is further based on the inclusion of at least one transaction data entry included in the identified specific account profile that includes the specific merchant identifier and an indication of being a non-recurring transaction.

3. The method of claim 1, further comprising:
storing, in a merchant database, a plurality of merchant profiles, wherein each merchant profile includes a structured data set related to one or more high-risk merchants including at least an associated merchant identifier, wherein
the likelihood of an unwanted recurring payment is further based on the inclusion of the specific merchant identifier stored in the third data element included in the received transaction message in at least one merchant profile stored in the merchant database.

4. The method of claim 3, wherein the likelihood of an unwanted recurring payment is even further based on a lack of transaction data entries included in the identified specific account profile that include the specific merchant identifier and an indication of being a non-recurring transaction.

5. The method of claim 1, wherein the merchant identifier is one of: a merchant identification number and a merchant category code.

6. A method for monitoring for unwanted recurring transactions, comprising:
storing, in an account database of a processing server, a plurality of account profiles, wherein each account profile includes a structured data set related to a transaction account including at least a primary account number, communication details, and a plurality of transaction data entries, each transaction data entry including data related to a completed transaction involving the related transaction account including at least a paid amount, merchant identifier, and indication of the related complete transaction being a recurring or non-recurring transaction;
receiving, by a receiving device of the processing server, a transaction message related to a payment transaction, wherein the transaction message is formatted pursuant to one or more standards and includes at least a plurality of data elements including at least a first data element configured to store a specific primary account number, a second data element configured to store a transaction amount, a third data element configured to store a specific merchant identifier, and a fourth data element configured to store an indication of a recurring payment transaction;
executing, by a querying module of the processing server, a query on the account database to identify a specific account profile where the included primary account number corresponds to the specific primary account number stored in the first data element included in the received transaction message;
identifying, by a data identification module of the processing server, at least one transaction data entry included in the identified specific account profile that includes the specific merchant identifier and an indication of being a recurring transaction;
determining, by the data identification module of the processing server, a likelihood of an unwanted recurring payment based on at least the transaction amount stored in the second data element included in the received transaction message and the paid amount included in each of the identified at least one transaction data entries; and
electronically transmitting, by a transmitting device of the processing server, a data signal to a computing device based on the communication details included in the identified specific account profile, wherein the data signal is superimposed with at least data stored in the plurality of data elements included in the received transaction message.

7. The method of claim 6, wherein
each transaction data entry further includes a transaction date, and
the likelihood of an unwanted recurring payment is further based on the paid amount included in a specific transaction data entry of the identified at least one transaction data entries being of a predetermined amount less than the transaction amount stored in the second data element included in the received transaction message, wherein
the specific transaction data entry includes a transaction date more recent than the transaction date included in each other transaction data entry included in the identified at least one transaction data entries.

8. The method of claim 7, wherein the predetermined amount is thirty percent.

9. The method of claim 6, wherein
each transaction data entry further includes a transaction date,
the data identification module identifies two or more transaction data entries that include the specific merchant identifier and an indication of being a recurring transaction, and
the likelihood of an unwanted recurring payment transaction is further based on a consistent increase in the paid amount included in a predetermined number of the identified two or more transaction data entries based on the paid amount and transaction date included in the identified two or more transaction data entries.

10. The method of claim 9, wherein the consistent increase is an increase in the paid amount by at least a predetermined amount.

11. A system for monitoring for unwanted recurring transactions, comprising:
an account database of a processing server configured to store a plurality of account profiles, wherein each account profile includes a structured data set related to a transaction account including at least a primary account number, communication details, and a plurality of transaction data entries, each transaction data entry including data related to a completed transaction involving the related transaction account including at least a paid amount, merchant identifier, and indication of the related complete transaction being a recurring or non-recurring transaction;
a receiving device of the processing server configured to receive a transaction message related to a payment transaction, wherein the transaction message is formatted pursuant to one or more standards and includes at least a plurality of data elements including at least a first data element configured to store a specific primary account number, a second data element configured to store a transaction amount, a third data element configured to store a specific merchant identifier, and a fourth data element configured to store an indication of a recurring payment transaction;
a querying module of the processing server configured to execute a query on the account database to identify a specific account profile where the included primary account number corresponds to the specific primary account number stored in the first data element included in the received transaction message;
a data identification module of the processing server configured to determine a likelihood of an unwanted recurring payment based on at least a lack of transaction data entries included in the identified specific account profile that include the specific merchant identifier and an indication of being a recurring transaction; and
a transmitting device of the processing server configured to electronically transmit a data signal to a computing device based on the communication details included in the identified specific account profile, wherein the data signal is superimposed with at least data stored in the plurality of data elements included in the received transaction message.

12. The system of claim 11, wherein the likelihood of an unwanted recurring payment is further based on the inclusion of at least one transaction data entry included in the identified specific account profile that includes the specific merchant identifier and an indication of being a non-recurring transaction.

13. The system of claim 11, further comprising:
a merchant database configured to store a plurality of merchant profiles, wherein each merchant profile includes a structured data set related to one or more high-risk merchants including at least an associated merchant identifier, wherein
the likelihood of an unwanted recurring payment is further based on the inclusion of the specific merchant identifier stored in the third data element included in the received transaction message in at least one merchant profile stored in the merchant database.

14. The system of claim 13, wherein the likelihood of an unwanted recurring payment is even further based on a lack of transaction data entries included in the identified specific account profile that include the specific merchant identifier and an indication of being a non-recurring transaction.

15. The system of claim 11, wherein the merchant identifier is one of: a merchant identification number and a merchant category code.

16. A system for monitoring for unwanted recurring transactions, comprising:
an account database of a processing server configured to store a plurality of account profiles, wherein each account profile includes a structured data set related to a transaction account including at least a primary account number, communication details, and a plurality of transaction data entries, each transaction data entry including data related to a completed transaction involving the related transaction account including at least a paid amount, merchant identifier, and indication of the related complete transaction being a recurring or non-recurring transaction;
a receiving device of the processing server configured to receive a transaction message related to a payment transaction, wherein the transaction message is formatted pursuant to one or more standards and includes at least a plurality of data elements including at least a first data element configured to store a specific primary account number, a second data element configured to store a transaction amount, a third data element configured to store a specific merchant identifier, and a fourth data element configured to store an indication of a recurring payment transaction;
a querying module of the processing server configured to execute a query on the account database to identify a specific account profile where the included primary account number corresponds to the specific primary account number stored in the first data element included in the received transaction message;
a data identification module of the processing server configured to
identify at least one transaction data entry included in the identified specific account profile that includes the specific merchant identifier and an indication of being a recurring transaction, and
determine a likelihood of an unwanted recurring payment based on at least the transaction amount stored in the second data element included in the received transaction message and the paid amount included in each of the identified at least one transaction data entries; and
a transmitting device of the processing server configured to electronically transmit a data signal to a computing device based on the communication details included in the identified specific account profile, wherein the data signal is superimposed with at least data stored in the plurality of data elements included in the received transaction message.

17. The system of claim 16, wherein
each transaction data entry further includes a transaction date, and
the likelihood of an unwanted recurring payment is further based on the paid amount included in a specific transaction data entry of the identified at least one transaction data entries being of a predetermined amount less than the transaction amount stored in the second data element included in the received transaction message, wherein
the specific transaction data entry includes a transaction date more recent than the transaction date included in each other transaction data entry included in the identified at least one transaction data entries.

18. The system of claim 17, wherein the predetermined amount is thirty percent.

19. The system of claim 16, wherein
each transaction data entry further includes a transaction date,
the data identification module identifies two or more transaction data entries that include the specific merchant identifier and an indication of being a recurring transaction, and
the likelihood of an unwanted recurring payment transaction is further based on a consistent increase in the paid amount included in a predetermined number of the identified two or more transaction data entries based on the paid amount and transaction date included in the identified two or more transaction data entries.

20. The system of claim 19, wherein the consistent increase is an increase in the paid amount by at least a predetermined amount.
